(19) United States
(12) Patent Application Publication
(10) Pub. No.: US 2014/0168874 A1
(43) Pub. Date: Jun. 19, 2014

(54) THERMAL MANAGEMENT FOR ELECTRONIC DEVICE

(71) Applicants: Mark MacDonald, Beaverton, OR (US); Carin L. Ruiz, San Jose, CA (US); Merwin M. Brown, Folsom, CA (US)

(72) Inventors: Mark MacDonald, Beaverton, OR (US); Carin L. Ruiz, San Jose, CA (US); Merwin M. Brown, Folsom, CA (US)

(21) Appl. No.: 13/719,546

(22) Filed: Dec. 19, 2012

(51) Int. Cl. G06F 1/20

(52) U.S. Cl. CPC G06F 1/20
USPC 361/679.08; 361/720; 361/707

(57) ABSTRACT

In one embodiment an assembly comprises a keyboard tray comprising a first side having a plurality of keys and a second side opposite the first side and a planar heat spreader to be in thermal communication with the second side of the keyboard tray. Other embodiments may be described.

### BACKGROUND

The subject matter described herein relates generally to the field of electronic devices and more particularly to a thermal management for one or more electronic devices.

Some electronic devices that include components which generate heat utilize active thermal management systems such as fans and/or blowers to conduct heat away from the components. Active thermal management systems consume power which reduces the battery charge life in mobile devices.

Accordingly passive thermal management techniques for electronic devices may find utility.

### BRIEF DESCRIPTION OF THE DRAWINGS

The detailed description is described with reference to the accompanying figures.

FIGS. 1-2 are schematic illustration of exemplary electronic devices which may be modified to include a thermal management in accordance with some embodiments.

FIGS. 3A-3C are schematic illustrations of assemblies for thermal management which may be incorporated into an electronic device, in accordance with some embodiments.

FIG. 4 is a schematic illustration of components of an exemplary electronic device which may be modified to include a thermal management in accordance with some embodiments.

### DETAILED DESCRIPTION

Described herein are exemplary embodiments assemblies for thermal management for an electronic device, and of electronic devices incorporating such assemblies. In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

In some embodiments, thermal management assemblies are employed in electronic devices for cooling purposes to eliminate, or at least reduce, the need for active cooling systems such as fans or blowers, which in turn eliminates, or at least reduces, fan acoustic noise and power consumption associated with fans and blowers. Thermal management assemblies may comprise a large surface area heat spreader which is to be placed in thermal communication with one side of a printed circuit board (e.g., a motherboard) comprising heat generating components and with a component that provides a heat conduction path to the ambient environment (e.g., a keyboard tray or a display tray). The heat spreader spreads heat from the printed circuit board over a relatively large surface area and conducts heat from the circuit board to the keyboard tray, display tray or other component, which may then conduct the heat to the ambient environment. Large surface area heat spreaders provide lower peak temperatures and higher surface areas which, in turn, provide increased overall heat dissipation.

In some embodiments the printed circuit board may be designed such that all heat generating electrical components are disposed on a first side of the circuit board, thereby leaving the entire second side of the circuit board available to be placed in thermal communication with the heat spreader and enabling the heat spreader to be placed such that it faces the second side of the circuit board in close physical proximity to the printed circuit board. In alternate embodiments electrical components may be positioned on both sides of the printed circuit board and the heat spreader may be adapted to accommodate the electrical components, e.g., by providing apertures in the heat spreader at locations corresponding to the positions of the electrical components on the printed circuit board.

The heat spreader may comprise a material having a relatively high thermal conductivity. Exemplary materials for the thermal spreader may include graphite, aluminum, copper, or other similar materials. In some embodiments a thermal interface material (TIM) may be interposed between the heat spreader and the circuit board. Suitable thermal interface materials may include a silicon-based oil doped with aluminum oxide, zinc oxide, or the like. The heat spreader may measure between about 12 inches in length and 5 inches in width, and may have a thickness that measures between 0.01 inches and 0.1 inches. In some embodiments the heat spreader covers a majority portion of the circuit board and conveys heat from a plurality of heat generating components on the circuit board.

In some embodiments a heat spreader may be packaged as an assembly integrated with other components of electronic devices. By way of example, in some embodiments a heat spreader may be packaged as an integrated component of a keyboard assembly for use with an electronic device such as a portable computer. By way of example, in some embodiments a heat spreader may be coupled to a keyboard tray, or may be configured to function as a keyboard tray. In other embodiments a heat spreader may be packaged as an integrated component of a display assembly for use with an electronic device such as a mobile phone or a tablet computer. In further embodiments a heat spreader may be packaged as an integrated component of a printed circuit board which may be incorporated into an electronic device such as a portable computer, mobile phone, or a tablet computer.

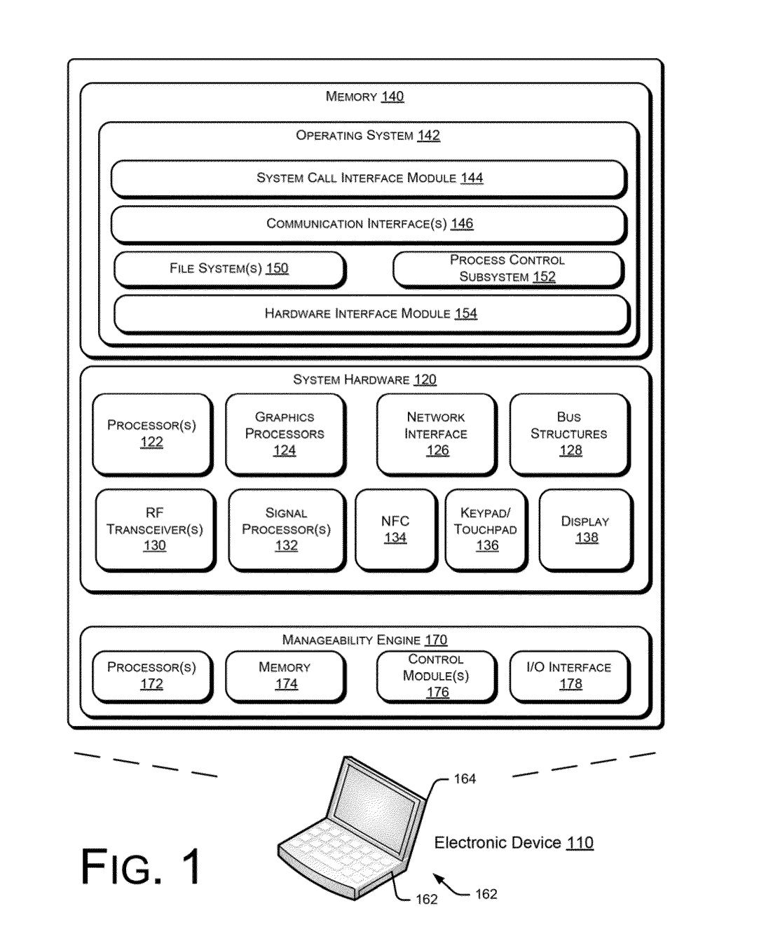

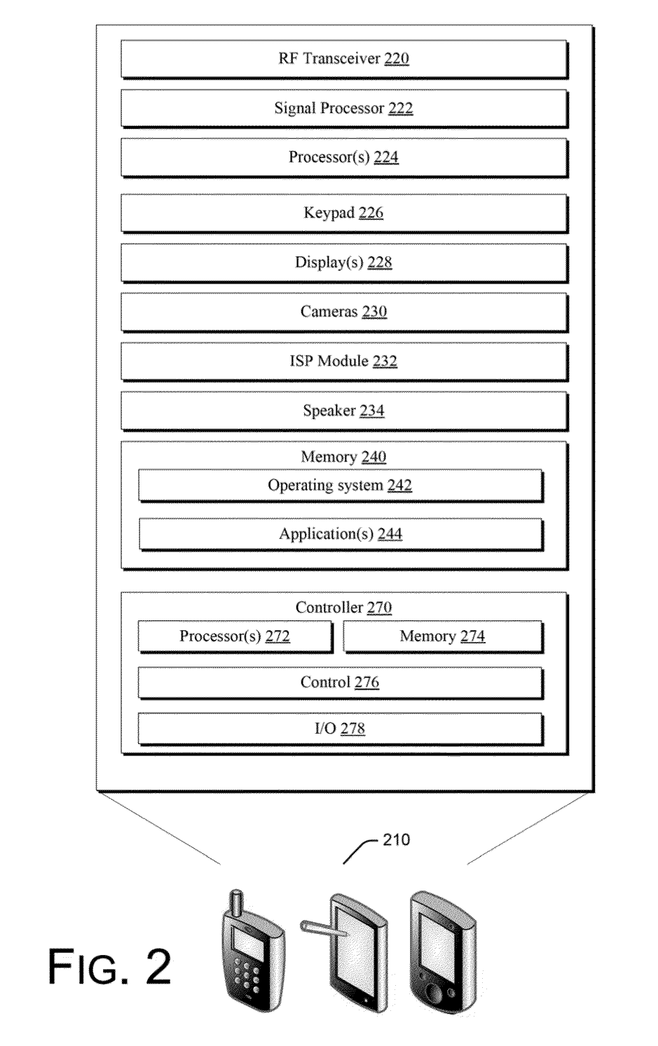

Exemplary electronic devices will be described with reference to FIGS. 1-2. FIG. 1 is a schematic illustration of an exemplary electronic device 110 which may be adapted to include a thermal management assembly in accordance with some embodiments. As illustrated in FIG. 1, electronic device 110 may be embodied as a conventional mobile device such as a laptop computer, a mobile phone, tablet computer portable computer, or personal digital assistant (PDA). The particular device configuration is not critical.

In various embodiments, electronic device 110 may include or be coupled to one or more accompanying input/output devices including a display, one or more speakers, a keyboard, one or more other I/O device(s), a mouse, a camera, or the like. Other exemplary I/O device(s) may include a touch screen, a voice-activated input device, a track ball, a geolocation device, an accelerometer/gyroscope, biometric feature input devices, and any other device that allows the electronic device 110 to receive input from a user.

The electronic device 110 includes system hardware 120 and memory 140, which may be implemented as random access memory and/or read-only memory. A file store may be communicatively coupled to computing device 110. The file store may be internal to computing device 110 such as, e.g., eMMC, SSD, one or more hard drives, or other types of storage devices. File store 180 may also be external to computer 110 such as, e.g., one or more external hard drives, network attached storage, or a separate storage network.

System hardware 120 may include one or more processors 122, graphics processors 124, network interfaces 126, and bus structures 128. In one embodiment, processor 122 may be embodied as an Intel® Atom™ processors, Intel® Atom™ based System-on-a-Chip (SOC) or Intel® Core2 Duo® or i3/i5/i7 series processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

Graphics processor(s) 124 may function as adjunct processor that manages graphics and/or video operations. Graphics processor(s) 124 may be integrated onto the motherboard of electronic device 110 or may be coupled via an expansion slot on the motherboard or may be located on the same die or same package as the Processing Unit.

In one embodiment, network interface 126 could be a wired interface such as an Ethernet interface (see, e.g., Institute of Electrical and Electronics Engineers/IEEE 802.3-2002) or a wireless interface such as an IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Bus structures 128 connect various components of system hardware 128. In one embodiment, bus structures 128 may be one or more of several types of bus structure(s) including a memory bus, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI), a High Speed Synchronous Serial Interface (HSI), a Serial Low-power Inter-chip Media Bus (SLIMbus®), or the like.

Electronic device 110 may include an RF transceiver 130 to transceive RF signals, a Near Field Communication (NFC) radio 134, and a signal processing module 132 to process signals received by RF transceiver 130. RF transceiver may implement a local wireless connection via a protocol such as, e.g., Bluetooth or 802.11 X. IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a WCDMA, LTE, general packet radio service (GPRS) interface (see, e.g., Guidelines on GPRS Handset Requirements, Global System for Mobile Communications/GSM Association, Ver. 3.0.1, December 2002).

Electronic device 110 may further include one or more input/output interfaces such as, e.g., a keypad 136 and a display 138. In some embodiments electronic device 110 may not have a keypad and use the touch panel for input.

Memory 140 may include an operating system 142 for managing operations of computing device 110. In one embodiment, operating system 142 includes a hardware interface module 154 that provides an interface to system hardware 120. In addition, operating system 140 may include a file system 150 that manages files used in the operation of computing device 110 and a process control subsystem 152 that manages processes executing on computing device 110.

Operating system 142 may include (or manage) one or more communication interfaces 146 that may operate in conjunction with system hardware 120 to transceive data packets and/or data streams from a remote source. Operating system 142 may further include a system call interface module 144 that provides an interface between the operating system 142 and one or more application modules resident in memory 130. Operating system 142 may be embodied as a UNIX operating system or any derivative thereof (e.g., Linux, Android, etc.) or as a Windows® brand operating system, or other operating systems.

In some embodiments an electronic device may include a manageability engine 170, which may comprise one or more controllers that are separate from the primary execution environment. The separation may be physical in the sense that the manageability engine may be implemented in controllers which are physically separate from the main processors. Alternatively, the trusted execution environment may logical in the sense that the manageability engine may be hosted on same chip or chipset that hosts the main processors.

By way of example, in some embodiments the manageability engine 170 may be implemented as an independent integrated circuit located on the motherboard of the electronic device 110, e.g., as a dedicated processor block on the same SOC die. In other embodiments the trusted execution engine may be implemented on a portion of the processor(s) 122 that is segregated from the rest of the processor(s) using hardware enforced mechanisms

In the embodiment depicted in FIG. 1 the manageability engine 170 comprises a processor 172, a memory module 174, a control module 176, and an I/O interface 178. In some embodiments the memory module 174 may comprise a persistent flash memory module and the various functional modules may be implemented as logic instructions encoded in the persistent memory module, e.g., firmware or software. The I/O module 178 may comprise a serial I/O module or a parallel I/O module. Because the manageability engine 170 is separate from the main processor(s) 122 and operating system 142, the manageability engine 170 may be made secure, i.e., inaccessible to hackers who typically mount software attacks from the host processor 122.

FIG. 2 is a schematic illustration of another embodiment of an electronic device 210 which may be adapted to include a thermal management assembly, according to embodiments. In some embodiments electronic device 210 may be embodied as a mobile telephone, a personal digital assistant (PDA), a laptop computer, or the like. Electronic device 210 may include an RF transceiver 220 to transceive RF signals and a signal processing module 222 to process signals received by RF transceiver 220.

RF transceiver 220 may implement a local wireless connection via a protocol such as, e.g., Bluetooth or 802.11X. IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Electronic device 210 may further include one or more processors 224 and a memory module 240. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit. In some embodiments, processor 224 may be one or more processors in the family of Intel® PXA27x processors available from Intel® Corporation of Santa Clara, Calif. Alternatively, other CPUs may be used, such as Intel's Itanium®. XEON™, ATOM™, and Celeron® processors. Also, one or more processors from other manufactures may be utilized. Moreover, the processors may have a single or multi core design.

In some embodiments, memory module 240 includes random access memory (RAM); however, memory module 240 may be implemented using other memory types such as dynamic RAM (DRAM), synchronous DRAM (SDRAM), and the like. Memory 240 may comprise an operating system 242 and one or more applications 244 which execute on the processor(s) 222.

Electronic device 210 may further include one or more input/output interfaces such as, e.g., a keypad 226 and one or more displays 228. In some embodiments electronic device 210 comprises one or more camera modules 230 and an image signal processor 232, and speakers 234.

In some embodiments electronic device 210 may include an adjunct controller 270 which may be implemented in a manner analogous to that of adjunct controller 170, described above. In the embodiment depicted in FIG. 2 the adjunct controller 270 comprises one or more processor(s) 272, a memory module 274, a control module 276, and an I/O module 278. In some embodiments the memory module 274 may comprise a persistent flash memory module and the authentication module 276 may be implemented as logic instructions encoded in the persistent memory module, e.g., firmware or software. The I/O module 278 may comprise a serial I/O module or a parallel 1/O module. Again, because the adjunct controller 270 is physically separate from the main processor(s) 224, the adjunct controller 270 may be made secure, i.e., inaccessible to hackers such that it cannot be tampered with.

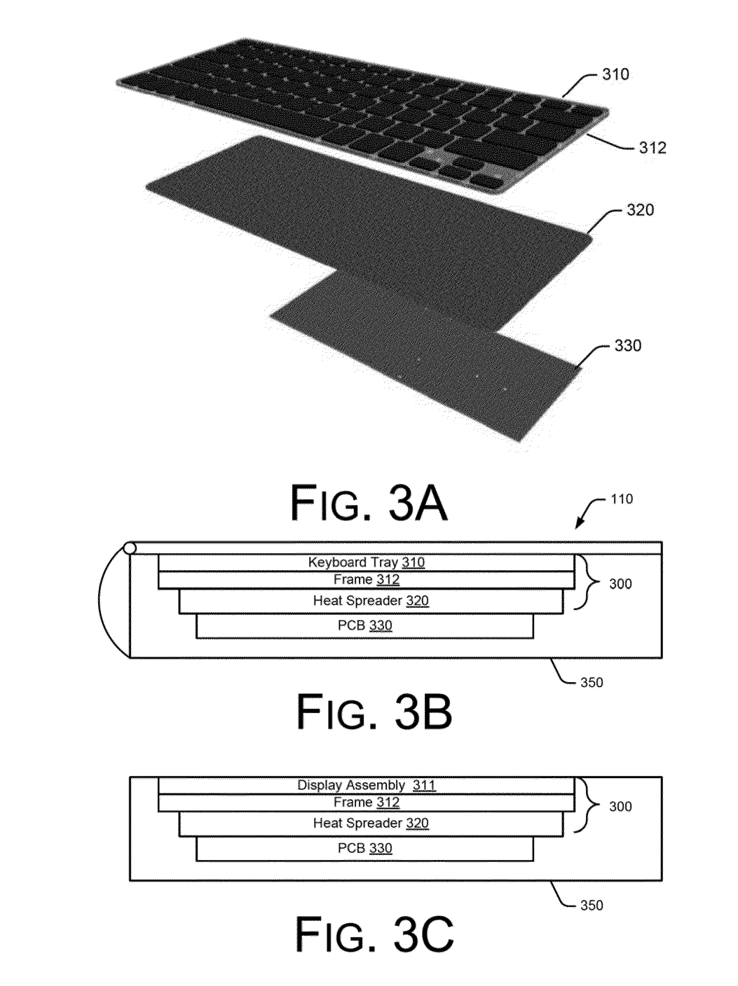

Embodiments of thermal management assemblies will be described with reference to FIGS. 3A-3C. Referring first to FIGS. 3A-3B, in some embodiments a thermal management assembly 300 which may be used with an electronic device 110 comprises a keyboard tray 310 having a plurality of keys disposed on a first side of the keyboard tray and a heat spreader 320 in thermal communication with the second side of the keyboard tray. In some embodiments the keyboard 310 comprises a frame 312, at least a portion of which may be formed from a metallic material. The heat spreader 320 may be coupled to the frame 312 such that heat spreader 320 and the keyboard tray form an integrated assembly 300.

In some embodiments the keyboard tray 310 may be coupled with the housing 350 of an electronic device 110 such that the frame of the keyboard tray is disposed within the housing 350 of the electronic device 110. The electronic device may comprise one or more printed circuit boards 330. In some embodiments the printed circuit board may comprise a plurality of electronic components disposed on a first side, and the heat spreader 330 may be in thermal communication with the second side of the printed circuit board 330. In use, heat generated by the printed circuit board 330 may be conducted to the heat spreader 320. Heat spreader 320 spreads the heat and conducts the heat to the keyboard tray 310, which conducts the heat to the ambient environment.

In other embodiments the heat spreader 320 may be packaged in combination with a display assembly 311 as illustrated in FIG. 3C to form a thermal management assembly 300 which may be used with an electronic device 110. Referring to FIG. 3C, in such embodiments a display assembly 311 comprises a frame 312, at least a portion of which may be formed from a metallic material. The heat spreader 320 may be coupled to the frame 312 such that heat spreader 320 and the display assembly 311 form an integrated assembly 300.

In some embodiments the display assembly 311 may be coupled with the housing 350 of an electronic device 110 such that the frame of the display assembly 311 is disposed within the housing 350 of the electronic device 110. The electronic device may comprise one or more printed circuit boards 330. In some embodiments the printed circuit board 330 may comprise a plurality of electronic components disposed on a first side, and the heat spreader 330 may be in thermal communication with the second side of the printed circuit board 330. In use, heat generated by the printed circuit board 330 may be conducted to the heat spreader 320. Heat spreader 320 spreads the heat and conducts the heat to the display assembly 311, which conducts the heat to the ambient environment.

In further embodiments the heat spreader 320 may be packaged in combination with the printed circuit board to form a thermal management assembly 300 which may be used with an electronic device 110. The heat spreader 320 may then be placed in thermal communication with a heat conducting component of a designer's choice to conduct heat from the printed circuit board 330 to the ambient environment.

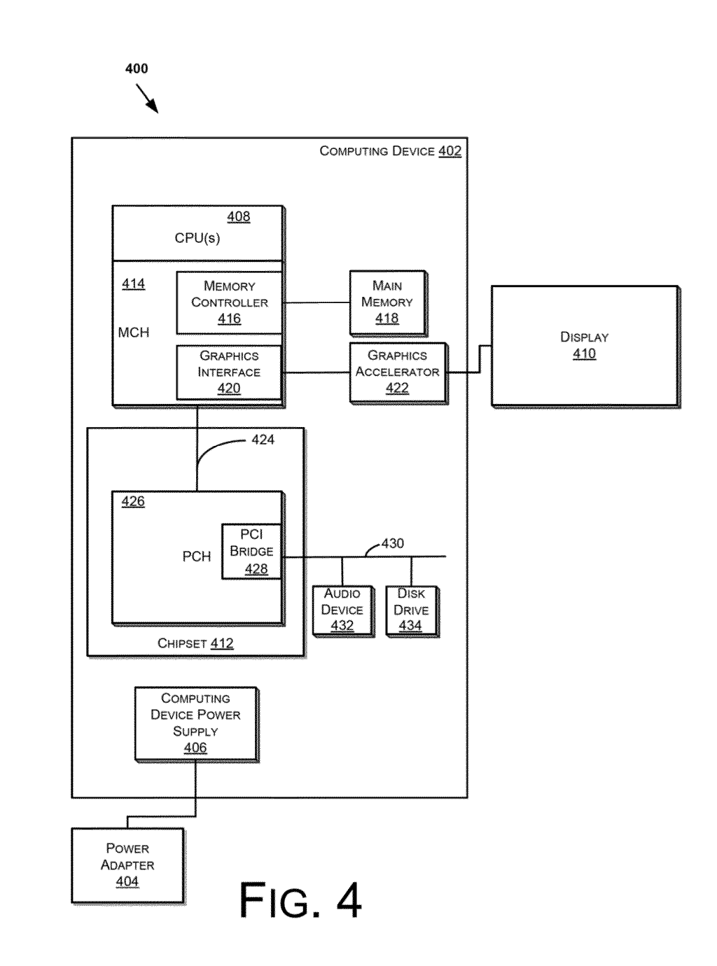

As described above, in some embodiments the electronic device may be embodied as a computer system. FIG. 4 is a schematic illustration of a computer system 400 in accordance with some embodiments. The computer system 400 includes a computing device 402 and a power adapter 404 (e.g., to supply electrical power to the computing device 402). The computing device 402 may be any suitable computing device such as a laptop (or notebook) computer, a personal digital assistant, a desktop computing device (e.g., a workstation or a desktop computer), a rack-mounted computing device, and the like.

Electrical power may be provided to various components of the computing device 402 (e.g., through a computing device power supply 406) from one or more of the following sources: one or more battery packs, an alternating current (AC) outlet (e.g., through a transformer and/or adaptor such as a power adapter 404), automotive power supplies, airplane power supplies, and the like. In some embodiments, the power adapter 404 may transform the power supply source output (e.g., the AC outlet voltage of about 110 VAC to 240 VAC) to a direct current (DC) voltage ranging between about 5 VDC to 12.6 VDC. Accordingly, the power adapter 404 may be an AC/DC adapter.

The computing device 402 may also include one or more central processing unit(s) (CPUs) 408. In some embodiments, the CPU 408 may be one or more processors in the Pentium® family of processors including the Pentium® II processor family, Pentium® III processors, Pentium®IV, or CORE2 Duo processors available from Intel® Corporation of Santa Clara, Calif. Alternatively, other CPUs may be used, such as Intel's Itanium®, XEO [symbol] , and Celeron® processors. Also, one or more processors from other manufactures may be utilized. Moreover, the processors may have a single or multi core design.

A chipset 412 may be coupled to, or integrated with, CPU 408. The chipset 412 may include a memory control hub (MCH) 414. The MCH 414 may include a memory controller 416 that is coupled to a main system memory 418. The main system memory 418 stores data and sequences of instructions that are executed by the CPU 408, or any other device included in the system 400. In some embodiments, the main system memory 418 includes random access memory (RAM); however, the main system memory 418 may be implemented using other memory types such as dynamic RAM (DRAM), synchronous DRAM (SDRAM), and the like. Additional devices may also be coupled to the bus 410, such as multiple CPUs and/or multiple system memories.

The MCH 414 may also include a graphics interface 420 coupled to a graphics accelerator 422. In some embodiments, the graphics interface 420 is coupled to the graphics accelerator 422 via an accelerated graphics port (AGP). In some embodiments, a display (such as a flat panel display) 440 may be coupled to the graphics interface 420 through, for example, a signal converter that translates a digital representation of an image stored in a storage device such as video memory or system memory into display signals that are interpreted and displayed by the display. The display 440 signals produced by the display device may pass through various control devices before being interpreted by and subsequently displayed on the display.

A hub interface 424 couples the MCH 414 to an platform control hub (PCH) 426. The PCH 426 provides an interface to input/output (I/O) devices coupled to the computer system 400. The PCH 426 may be coupled to a peripheral component interconnect (PCI) bus. Hence, the PCH 426 includes a PCI bridge 428 that provides an interface to a PCI bus 430. The PCI bridge 428 provides a data path between the CPU 408 and peripheral devices. Additionally, other types of I/O interconnect topologies may be utilized such as the PCI Express® architecture, available through Intel® Corporation of Santa Clara, Calif.

The PCI bus 430 may be coupled to an audio device 432 and one or more disk drive(s) 434. Other devices may be coupled to the PCI bus 430. In addition, the CPU 408 and the MCH 414 may be combined to form a single chip. Furthermore, the graphics accelerator 422 may be included within the MCH 414 in other embodiments.

Additionally, other peripherals coupled to the PCH 426 may include, in various embodiments, integrated drive electronics (IDE) or small computer system interface (SCSI) hard drive(s), universal serial bus (USB) port(s), a keyboard, a mouse, parallel port(s), serial port(s), floppy disk drive(s), digital output support (e.g., digital video interface (DVI)), and the like. Hence, the computing device 402 may include volatile and/or nonvolatile memory.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and embodiments are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and embodiments are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one embodiment” or “some embodiments” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An assembly, comprising:
a keyboard tray comprising
a first side having a plurality of keys; and
a second side opposite the first side; and
a planar heat spreader to be in thermal communication with the second side of the keyboard tray.

2. The assembly of claim 1, wherein:
the keyboard tray comprises a frame, at least a portion of which is formed from a metallic material; and
the heat spreader is to be coupled to the frame.

3. The assembly of claim 1, wherein:
the heat spreader is to function as a frame for the keyboard tray.

4. The assembly of claim 1, further comprising:
a circuit board comprising:
a first side having a plurality of electronic components; and
a second side opposite the first side and facing toward the heat spreader.

5. The assembly of claim 4, wherein:
the keyboard tray is to be coupled with a housing of an electronic device such that the second side of the keyboard tray is to be disposed within the housing.

6. The assembly of claim 4, wherein the heat spreader is to distribute heat generated by the plurality of electronic components across a surface area of the heat spreader and to transmit the heat to the keyboard tray.

7. An electronic device, comprising:
a housing;
a keyboard tray coupled to the housing and comprising
a first side having a plurality of keys; and
a second side opposite the first side; and
a planar heat spreader to be in thermal communication with the second side of the keyboard tray.

8. The electronic device of claim 7, wherein:
the keyboard tray comprises a frame, at least a portion of which is formed from a metallic material; and
the heat spreader is to be coupled to the frame.

9. The electronic device of claim 7, wherein:
the heat spreader is to function as a frame for the keyboard tray.

10. The electronic device of claim 7, further comprising:
a printed circuit board comprising:
a first side having a plurality of electronic components; and
a second side opposite the first side and facing toward the heat spreader.

11. The electronic device of claim 10, wherein the heat spreader is to distribute heat generated by the plurality of electronic components across a surface area of the heat spreader and to transmit the heat to the keyboard tray.

12. An assembly, comprising:
a circuit board comprising:
a first side having a plurality of electronic components; and
a second side opposite the first side; and
a planar heat spreader to be in thermal communication with the second side of the printed circuit board.

13. The assembly of claim 12, wherein the planar heat spreader covers a majority portion of the circuit board.

14. The assembly of claim 13, wherein the planar heat spreader extracts heat from a plurality of heat-generating components on the circuit board.

15. The assembly of claim 12, further comprising:
a display assembly comprising
a first side having a display; and
a second side opposite the first side and in thermal communication with the heat spreader.

16. The assembly of claim 15, wherein:
the display assembly comprises a frame, at least a portion of which is formed from a metallic material; and
the heat spreader is to be coupled to the frame.

17. The assembly of claim 15, wherein:
the display assembly is to be coupled with a housing of an electronic device such that the second side of the display assembly is to be disposed within the housing.

18. The assembly of claim 15, wherein the heat spreader is to distribute heat generated by the plurality of electronic components across a surface area of the heat spreader and to transmit the heat to the display assembly.

19. An electronic device, comprising:
a housing;
a circuit board comprising:
a first side having a plurality of electronic components; and
a second side opposite the first side; and
a planar heat spreader to be in thermal communication with the second side of the printed circuit board.

20. The electronic device of claim 19, wherein the planar heat spreader covers a majority portion of the circuit board.

21. The electronic device of claim 19, wherein the planar heat spreader extracts heat from a plurality of heat-generating components on the circuit board.

22. The electronic device of claim 21, further comprising:
a display assembly comprising
a first side having a display; and
a second side opposite the first side and in thermal communication with the heat spreader.

23. The electronic device of claim 22, wherein:
the display assembly comprises a frame, at least a portion of which is formed from a metallic material; and
the heat spreader is to be coupled to the frame.

24. The electronic device of claim 22, wherein:
the display assembly is to be coupled with a housing of an electronic device such that the second side of the display assembly is to be disposed within the housing.

25. The electronic device of claim 22, wherein the heat spreader is to distribute heat generated by the plurality of electronic components across a surface area of the heat spreader and to transmit the heat to the display assembly.
